(19) United States
(12) Patent Application Publication
(10) Pub. No.: US 2009/0119930 A1
(43) Pub. Date: May 14, 2009

(54) Hand-Held Tool For Grout Removal

(75) Inventor: Kipp P. Collins, Edmond, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: M-D Building Products, Inc., Oklahoma City, OK (US)

(21) Appl. No.: 11/938,912

(22) Filed: Nov. 13, 2007

(51) Int. Cl. B26B 27/00

(52) U.S. Cl. 30/277.4; 30/272.1

(57) ABSTRACT

A hand-held tool. The tool comprises an interchangeable blade or blades located at an end of an L-shaped frame. The frame has a first portion and a second portion, the first portion attached at its end to the second portion in perpendicular fashion. The blade is located at an end of the second portion and has a working edge, which may be sharp, rough, serrated, or otherwise adapted for an application. A motor supported inside the frame provides reciprocal motion to the blade, the motion in a direction parallel to a length of the first portion of the L-shaped frame.

### FIELD OF THE INVENTION

The present invention relates to the field of hand-held household tools, and particularly to tools for grout removal.

### SUMMARY OF THE INVENTION

The present invention is directed to a handheld tool. The handheld tool comprises a frame, a blade actuator, a first blade, and a motor. The fame comprises a handle and is characterized by a length. The blade actuator is supported by the frame. The first blade comprises a working edge, and the first blade is attachable to the blade actuator such that the working edge is substantially parallel to the length of the frame. The motor is supported by the frame and operatively connected to the blade actuator. The blade actuator is adapted to move in a reciprocating fashion such that the working edge of the blade moves in a direction substantially parallel to the length of the frame.

Another embodiment of the present invention is directed to a handheld tool. The handheld tool comprises a frame, an actuator supported by the frame, and a blade. The frame comprises a first portion and a second portion. The first portion defines a handle. The first portion further has a first end and a second end, and is characterized by a length. The second portion is attached to the second end of the first portion and substantially perpendicular to the first portion, the second portion defining a slot substantially parallel to the length of the first portion. The blade comprises a working edge. The blade is connectable to the actuator proximate the slot such that the working edge is substantially parallel to the length of the first portion of the frame.

### BRIEF DESCRIPTION OF THE DRAWINGS

FIG. 1 is a side view of a hand-held tool.

FIG. 2A is a cut-away partial side view of the hand-held tool of FIG. 1.

FIG. 2B is a cut-away partial side view of an alternative embodiment of the hand-held tool of FIG. 1.

FIG. 2C is a cut-away partial side view of another alternative embodiment of the hand-held tool of FIG. 1.

FIG. 3 is a cross-sectional side view of a hand-held tool.

### DETAILED DESCRIPTION OF THE PREFERRED EMBODIMENTS

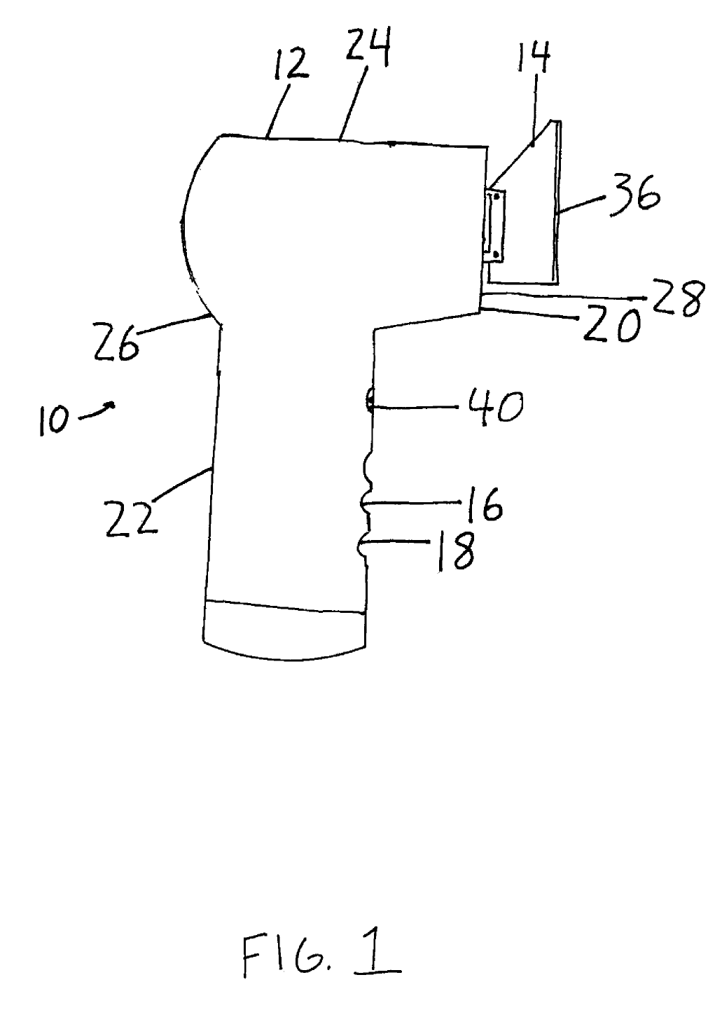

Turning now to the drawings in general and FIG. 1 in particular, shown therein is a handheld tool, specifically referred to herein as a mechanical grout removal assembly 10. The grout removal assembly 10 comprises a frame or housing 12 and a blade 14. The frame 12 is at least partially hollow. The frame 12 houses and protects essential components of the grout removal assembly 10. Preferably the frame 12 is made of a plastic material, but other materials may be used, either alone or in combination with plastic.

The frame 12 preferably comprises a first portion 16 and a second portion 18. The first portion 16 comprises a first end 20 and a second end 22, and is characterized by a length. The first portion 16 of the frame 12 preferably comprises a handle 24 proximate the first end 20. The handle 24 is adapted to be held by an operator while using the grout removal assembly 10. In the preferred embodiment, the handle 24 comprises a grip 26 around a circumference of the first portion 16 of the frame 12. The grip 26 may comprise ridges 28 or a rubber surface to increase the friction between the grout removal assembly 10 and a hand of the operator. Alternatively, the handle 24 may also be an apparatus separately attachable to the first portion 16, or other parts of the frame 12, for grasping by the operator.

The second portion 18 of the frame 12 is preferably connected to the second end 22 of the first portion 16 of the frame. More preferably, the second portion 18 is substantially perpendicular to the first portion 16. The second portion 18 of the frame 12 defines a connection location, or slot 30. The slot 30 is preferably parallel to the length of the first portion 16 of the frame 12. The blade 14 is connected to the frame 12 proximate the slot 30. In operation, as yet to be described, the blade 14 will move in reciprocating fashion along a length of the slot 30.

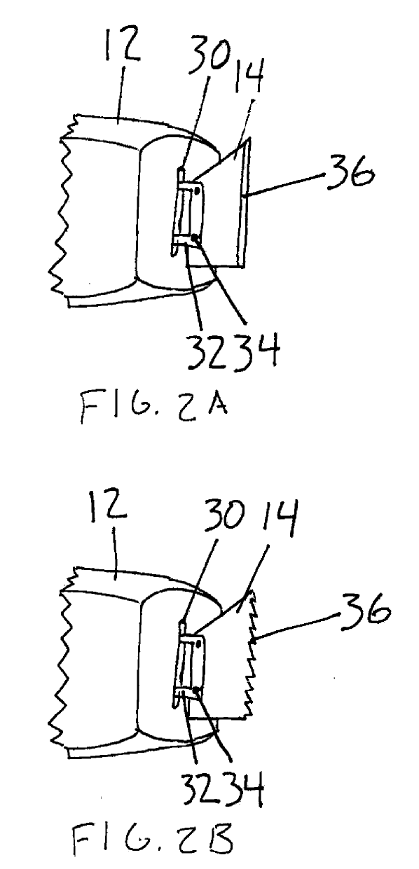

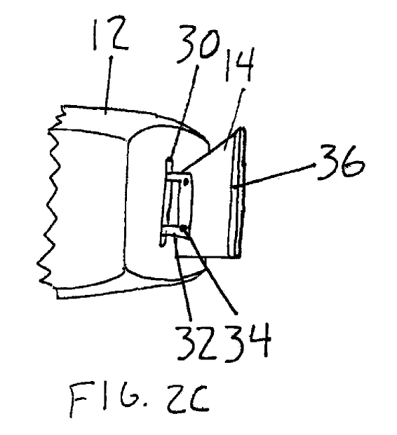

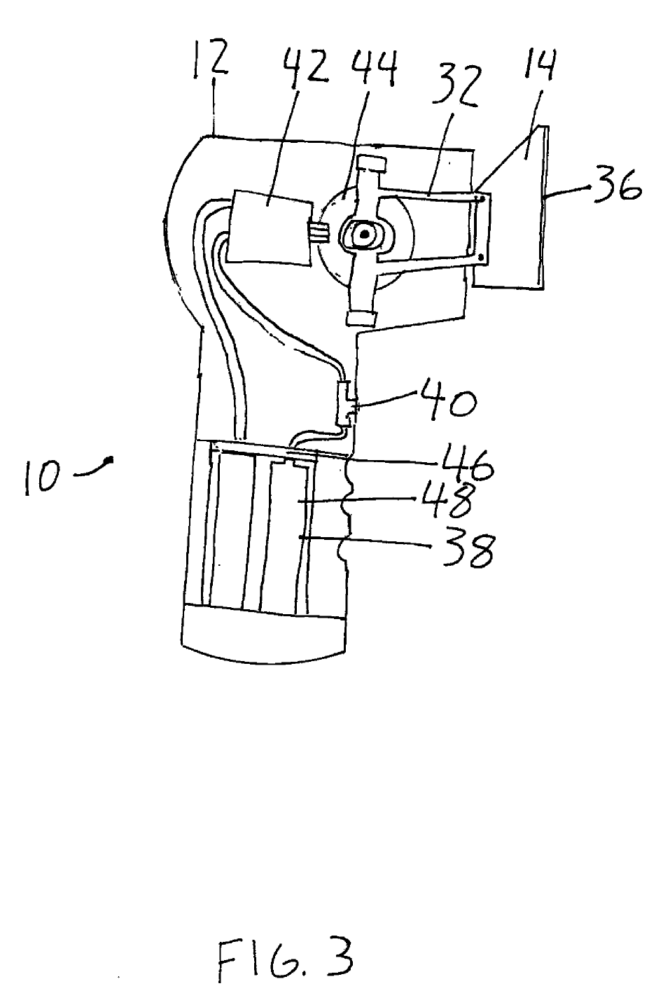

Turning now to FIG. 2A, the blade 14 is shown in more detail. As shown in FIG. 2A, a blade connection assembly or blade actuator 32 extends from the frame 12 and through the slot 30. The blade 14 is removably attached to blade actuator 32. Preferably, the blade 14 is attached to the blade actuator 32 with connection means 34 such as screws. Alternatively, the blade 14 may extend through the slot 30 for connection to operative components of the grout removal assembly 10, yet to be described.

The blade 14 is preferably made of steel or any other suitably durable material and comprises a working edge 36. The working edge 36 has an abrasive surface. Preferably, a blade 14 may be chosen for its working edge 36 depending on the application. For example, as shown in FIG. 2A, a rough, flat surface with an abrasive quality causes the working edge 36 to be effective at dislodging residue from grout and removing grout from a working space. Alternatively, as shown in FIG. 2B, a serrated working edge 36 is also effective for dislodging grout from a working space. When an area of grout is wider, a blade with a wider working edge, or multiple blades as shown in FIG. 2C, may be used.

The working edge 36 is substantially parallel to the slot 30 and, therefore, parallel to the length of the first portion 16 of the frame 12. Preferably, the working edge 36 is longer than the slot 30. The parallel orientation of the working edge 36 to the length of the first portion 16, and thus the handle 24, allows for ease of operation and minimizes the strain placed on the blade actuator 32 and the blade 14 when a force is exerted on the working edge 36. With reference again to FIG. 1, the grout removal assembly 10 has a familiar orientation to an operator, similar to that of a cordless drill or nail gun.

Turning now to FIG. 3, shown therein are the operative components of the grout removal assembly 10 housed inside the frame 12. The grout removal assembly 10 further comprises a battery assembly 38, a motor actuator 40, a motor 42, and a cam mechanism 44. The battery assembly 38 is supported in the flame 12 and adapted to provide power to the motor 42. The motor actuator 40 controls the flow of power from the battery assembly 38 to the motor 42. The cam mechanism 44 is operatively connected to the motor 42, and adapted to convert power provided by the motor to reciprocal motion in the blade actuator 32.

The battery assembly 38 preferably is supported by the first portion 16 of the frame 12. The battery assembly 38 comprises a terminal 46 and a battery pack 48. The battery pack 48 is connectable to the battery terminal 46. Preferably, the battery pack 48 is easily detachable from the frame 12. The battery pack 48 may comprise AA batteries, or any conventional power source, such as a rechargeable module.

The motor actuator 40 is supported on the first portion 16 of the frame 12. Preferably, the motor actuator 40 is arranged proximate the handle 16, and accessible to an operator from outside of the frame 12. The actuator 40 is adapted to interrupt the flow of electricity from the battery assembly to the motor. As shown, the actuator 40 comprises an on-off switch. Alternatively, the actuator 40 may allow for incremental changes in the amount of electricity delivered to the motor 42.

The motor 42 is supported in the second portion 18 of the frame 12. The motor 42 is adapted to operatively interact with the cam mechanism 44 when activated. The cam mechanism 44 converts motion produced by the motor 42 into reciprocating motion. Preferably, the cam mechanism 44 causes the blade actuator 32 to reciprocate. The cam mechanism 44 may be integrated with the motor 42, or may comprise a separate assembly connectable to the motor.

To use the assembly 10, a user must first identify a working area to be cleaned, such as a section of grout between tiles. In a preferred embodiment, an optimal blade 14 is chosen from a plurality of blades. As discussed above, an optimal blade 14 may have a serrated or jagged edge if the user desires to remove the grout. Alternatively, a flat, rough blade 14 may be utilized if the user intends to remove grout residue and loosen or remove grout from the working area. Blades with varying width, or multiple blades, may be chosen to accommodate regions with larger widths.

The blade 14 is placed at a location along the section of grout. The motor actuator 40 is activated, initiating operation of the motor 42 and imparting a reciprocating motion to the blade 14. The grout removal assembly 10 is firmly held against the section of grout, and slowly moved lengthwise along the section as residue is removed from the grout. When the grout or grout residue has been dislodged to satisfaction, a second pass may be made at the working area may be made with the same or an alternative blade 14. Dislodged residue and grout can be further removed by any number of means, such as mopping the section or removing the residue with a cloth.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. A handheld tool comprising:
a frame comprising a handle, the frame characterized by a length;
a blade actuator supported by the frame;
a first blade comprising a working edge, the blade attachable to the blade actuator such that the working edge is substantially parallel to the length of the frame;
a motor supported by the frame, the motor operatively connected to the blade actuator;
wherein the blade actuator is adapted to move in a reciprocating fashion such that the working edge of the blade moves in a direction substantially parallel to the length of the frame.

2. The tool of claim 1 wherein the frame defines a slot and wherein the blade is connected to the blade actuator through the slot.

3. The tool of claim 1 wherein the frame comprises a first portion and a second portion, wherein the first portion is substantially perpendicular to the second portion, and wherein the first portion comprises the handle and the second portion supports the blade actuator.

4. The tool of claim 1 wherein the working edge of the blade is serrated.

5. The tool of claim 1 wherein the first blade comprises a carbide grit blade.

6. The tool of claim 1 further comprising a second blade attachable to the blade actuator proximate the first blade.

7. A handheld tool comprising:
a frame comprising:
a first portion defining a handle, the first portion having a first end and a second end, and characterized by a length; and
a second portion attached to the second end of the first portion and substantially perpendicular to the first portion, the second portion defining a slot substantially parallel to the length of the first portion;
an actuator supported by the frame; and
a blade comprising a working edge, the blade connectable to the actuator proximate the slot such that the working edge is substantially parallel to the length of the first portion of the frame.
wherein the actuator is adapted to impart reciprocating motion to the blade.

8. The tool of claim 7 wherein the actuator comprises:
a motor having an output shaft;
a cam assembly operatively connected to the output shaft; and
a blade connector operatively connected to the cam assembly and attachable to the blade;
the cam assembly adapted to convert a rotational motion of the output shaft to a reciprocating motion of the blade connector.
